(19) United States
(12) Patent Application Publication
(10) Pub. No.: US 2014/0179155 A1
(43) Pub. Date: Jun. 26, 2014

(54) JUMPER ASSEMBLY

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: WEI PANG, Shenzhen (CN); JUN-HUI WANG, Shenzhen (CN); AI-LING HE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/802,821

(22) Filed: Mar. 14, 2013

(30) Foreign Application Priority Data
Dec. 26, 2012 (CN) 201210570924.6

(51) Int. Cl. H01R 13/46

(52) U.S. Cl. CPC H01R 13/46
USPC 439/507

(57) ABSTRACT

A jumper assembly includes a connector and a jumper. The connector includes a main body, and a number of pins attached to the main body and arranged a row. Two hooking slots are defined in opposite sides of the main body. The jumper includes a conductive tab formed at a bottom of the jumper, and two hooks formed at opposite sides of the jumper and slidably engaging in the hooking slots. When the jumper is slid to allow opposite ends of the conductive tab to contact two neighboring pins of the number of pins, the conductive tab connects the neighboring pins. When the jumper is slid to allow a middle of the conductive tab to contact one of the pins in the middle, the conductive tab do not contact any other pin.

### BACKGROUND

1. Technical Field

The present disclosure relates to a jumper assembly.

2. Description of Related Art

A jumper is generally used to connect two pins of a connector of a motherboard in a computer. The jumper needs to be removed from the connector or plugged in the connector frequently. However, the jumper is very small, and once the jumper is removed from the connector, the jumper may be lost or misplaced, and cannot easily be found.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a jumper assembly, wherein the jumper assembly includes a jumper.

FIG. 2 is an inverted view of the jumper of FIG. 1.

FIG. 3 is an assembled, isometric view of FIG. 1.

FIG. 4 is a part of a cross-sectional view taken along the line IV-IV in FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

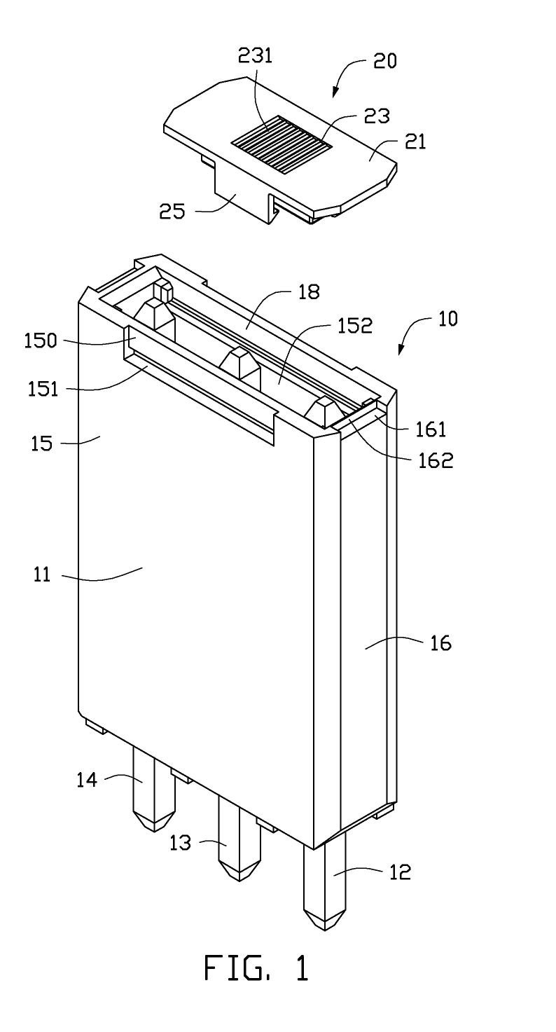

FIG. 1 shows an exemplary embodiment of a jumper assembly. The jumper assembly includes a connector 10 and a jumper 20.

The connector 10 includes a main body 11. The main body 11 includes two opposite first sidewalls 15, and two opposite second sidewalls 16 connected between corresponding sides of the first sidewalls 15. The first sidewalls 15 and the second sidewalls 16 bound a receiving slot 18 extending through a top end of the main body 11. A first pin 12, a second pin 13, and a third pin 14 are arranged in a row and orderly attached to the main body 11. Top ends of the first pin 12, the second pin 13, and the third pin 14 are received in the receiving slot 18. Bottom ends of the first pin 12, the second pin 13, and the third pin 14 are extended out of a bottom end of the main body 11. A recess 150 is defined in an upper portion of an outer surface of each first sidewall 15, extending through a top end of the first sidewall 15. A hooking slot 151 is defined in a bottom wall of each recess 150, opposite to the top end of the first sidewall 15. A supporting portion 152 extends from an upper portion of an inner surface of each first sidewall 15 toward the other first sidewall 15. A recess 161 is defined in a top end of each end wall 16. Each recess 161 includes a slot wall 162 bounding the receiving slot 18.

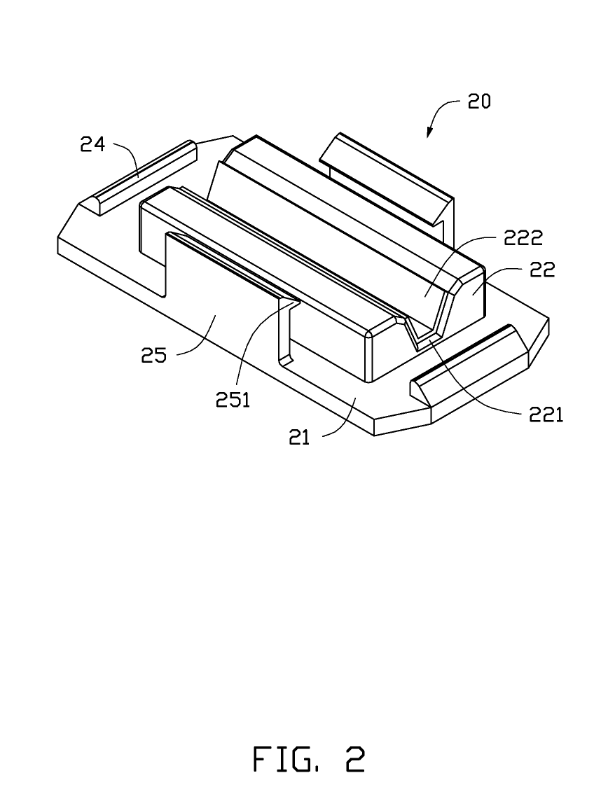

FIG. 2 shows the jumper 20 including a top plate 21, and a slide block 22 extending down from a bottom surface of the top plate 21. An operation portion 23 is formed on a center of a top surface of the top plate 21. The operation portion 23 includes a plurality of antiskid strips 231. Two substantially wedge-shaped resilient portions 24 extend from opposite ends of the bottom surface of the top plate 21. Two substantially L-shaped hooks 25 extend from middles of opposite sides of the bottom surface of the top plate 21. Each hook 25 includes a substantially wedge-shaped hooking portion 251 at a distal end of the hook 25, facing the other hook 25. A groove 221 is defined in a bottom surface of the slide block 22, extending through opposite ends of the slide block 22. The groove 221 has an isosceles trapezoid-shaped cross-section. A substantially U-shaped conductive tab 222 is attached to inner surfaces of the groove 221. A length of the conductive tab 222 is less than a distance between the first pin 12 and the third pin 14, but greater than a distance between the second pin 13 and each of the first and third pins 12 and 14.

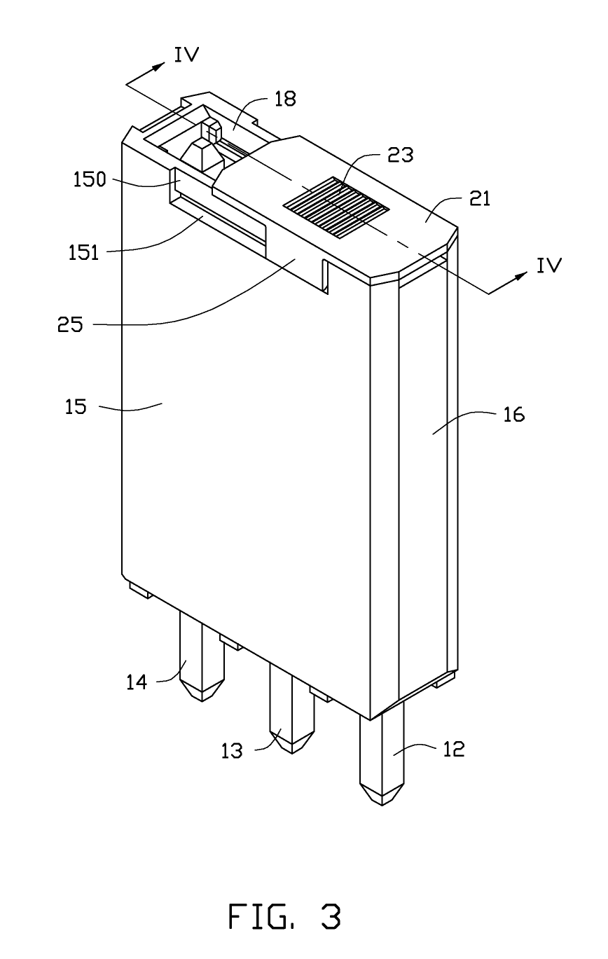

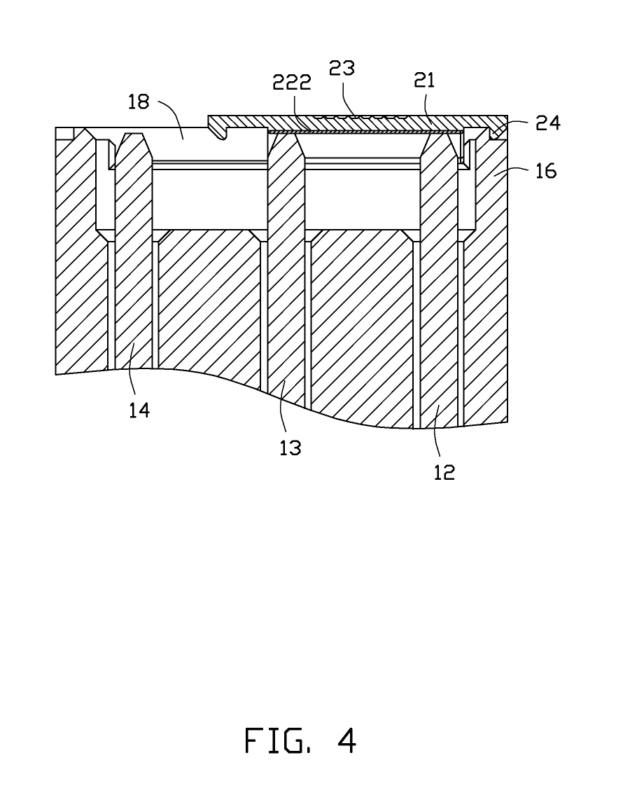

FIGS. 3 and 4 show in assembly. The slide block 22 is received in the receiving slot 18 and supported on the supporting portions 152. The top plate 21 abuts against top ends of the sidewalls 15. The hooks 25 are received in the recesses 150, and the hooking portions 251 engage in the hooking slots 151. The operation portion 23 is operated, to allow the jumper 20 to slide along the supporting portions 152. When not being used, a middle of the conductive tab 222 sandwiches the second pin 13, and the conductive tab 222 does not contact the first pin 12 and the third pin 14. In use, the jumper 20 is slid toward the first pin 12. The resilient portion 24 near the first pin 12 is deformed when slidably abutting against the corresponding second sidewall 16, and then enters the corresponding recess 161 to abut against the corresponding slot wall 162. The conductive tab 222 sandwiches the first pin 12 and the second pin 13, to connect the first pin 12 to the second pin 13. The jumper 20 is slid toward the third pin 14. The resilient portion 24 near the third pin 14 is deformed when slidably abutting the corresponding second sidewall 16 near the third pin 14, and then enters the corresponding recess 161 to abut against the slot wall 162. The conductive tab 222 sandwiches the second pin 13 and the third pin 14, to connect the second pin 13 to the third pin 14.

The jumper 20 is slidable relative to the connector 10. Even if the jumper 20 is not used to connect the first pin 12 and the second pin 13, or the third pin 14 and the second pin 13, it is not necessary to remove the jumper 20 from the connector 10. Therefore, the jumper 20 is not easily lost.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A jumper assembly, comprising:
a connector comprising a main body, and a plurality of pins received in the main body and arranged a row, opposite sides of the main body defining two hooking slots; and
a jumper comprising a conductive tab attached to a bottom of the jumper, and two hooks extending from opposite sides of the jumper and slidably engaging in the hooking slots;
wherein when the jumper is slid to allow the conductive tab to contact two neighboring pins of the plurality of pins, the conductive tab connects the neighboring pins, and when the jumper is slid to allow a middle of the conductive tab to contact one of the plurality of pins, the conductive tab do not contact any other pin.

2. The jumper assembly of claim 1, wherein the main body comprises two opposite first sidewalls and two opposite second sidewalls connected between corresponding sides of the first sidewalls, the first sidewalls and the second sidewalls bound a receiving slot, top ends of the plurality of pins are received in the receiving slot, the jumper is slidably connected to a top end of the main body.

3. The jumper assembly of claim 2, wherein a supporting portion extends from an inner surface of each first sidewall toward the other sidewall, the jumper comprises a top plate, and a slide block extending down from the top plate and received in the receiving slot, the slide block slidably supported on the supporting portions.

4. The jumper assembly of claim 3, wherein the top plate abuts against the top ends of the sidewalls.

5. The jumper assembly of claim 3, wherein a groove is defined in a bottom surface of the slide block, the conductive tab is attached to inner surfaces of the groove.

6. The jumper assembly of claim 2, wherein a recess is defined in an outer surface of each first sidewall, the hooks are slidably received in the recesses.

7. The jumper assembly of claim 6, wherein each hooking slot is defined in a bottom wall of each recess opposite to the top end of the main body, each hook comprises a hooking portion formed at a distal end of the hook, the hooking portions slidably engage in the hooking slots.

8. The jumper assembly of claim 2, wherein a recess is defined in a top end of each second sidewall, two resilient portions are formed on opposite ends of the jumper, when the conductive tab contacts two neighboring pins of the plurality of pins near one of the second sidewalls, the corresponding resilient portion engages in the recess of the one of the second sidewalls.

9. The jumper assembly of claim 1, wherein the conductive tab is substantially U-shaped in cross-section, the conductive tab contacts the corresponding pins through sandwiching the pins.

10. The jumper assembly of claim 1, wherein an operation portion comprising a plurality of antiskid strips is formed on a top surface of the jumper.
